(19) United States
(12) Patent Application Publication
(10) Pub. No.: US 2004/0015281 A1
(43) Pub. Date: Jan. 22, 2004

(54) Electronic control system, particularly for a vehicle brake system

(76) Inventor: Reinhard Weiberle, Vaihingen/Enz (DE)

Correspondence Address: KENYON & KENYON, ONE BROADWAY, NEW YORK, NY, 10004, US

(21) Appl. No.: 10/297,964

(22) PCT Filed: Mar. 16, 2002
(86) PCT No.: PCT/DE02/00973

(30) Foreign Application Priority Data
Apr. 12, 2001 (DE) 10118263.5

(51) Int. Cl. G06G 7/00; G06F 19/00

(52) U.S. Cl. 701/70

(57) ABSTRACT

An electronic control system is described, especially for a vehicle braking system, in which, for each brake circuit, a brake module is provided with which at least one actuator is associated, a local electronic unit for executing actuator-specific and/or sensor-specific control functions and/or evaluation functions is associated with each brake actuator, both structurally and logically, which are connected to the brake module of the respective brake circuit via a local brake circuit data bus. In addition, a communications system is provided by which the brake modules are connected to one another and to at least one driver input module as well as an additional control module for setting a control function outside the vehicle braking system.

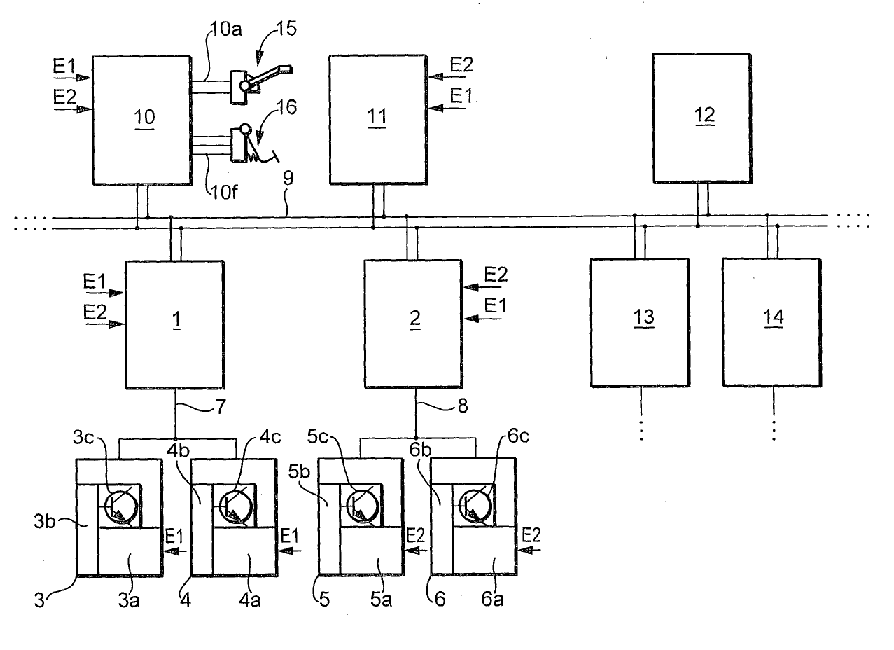

### BACKGROUND INFORMATION

The present invention relates to an electronic control system, especially for a vehicle braking system.

Such an electrical control system is known from the example of an electrical braking system for motor vehicles from DE-A 196 34 657 (U.S. Pat. No. 5,952,799). The control system described there has a control module for ascertaining the driver input and control modules for setting the braking force at the vehicle wheels, such a control module preferably actuating a group of wheel brakes combined by axle or diagonally. In order to connect the control module recording the driver input with the control modules for setting the braking force, at least one communications system (bus system) is provided. In order to be able to ensure an at least partial operability of the braking system in case of a fault, additional communications connections independent of the communications system between the control module for recording the driver input and the control modules for setting the braking force are provided.

The power electronics for controlling the actuators operating the wheel brakes (e.g. electric motors) is structurally integrated into the control modules for setting the braking power. Because of this, the transmission of synchronized currents from the control unit to the braking actuators is necessary, which may lead to considerable EMV (electromagnetic compatibility) problems. Because of this, it is stated in DE-A 198 26 131 that control modules having integrated power electronics in each case only operate one braking actuator, and are thus positioned spatially near the actuator. However, this is a disadvantage with regard to the number of control modules, since each control module has at least one microcomputer, and also to the number of microcomputers in the entire control system.

### SUMMARY OF THE INVENTION

Because of the hardware-related separation of the control and regulating functions on the one hand, and the actuator-specific control and evaluating functions on the other hand, the above-described conflict of aims of low electromagnetic interference and comparatively low number of control modules and/or microcomputers is solved.

It is advantageous, particularly with respect to the electromagnetic spurious radiation, if the regulating algorithms and monitoring functions of each braking circuit are designed as braking circuit control modules (braking modules), while the actuator-specific control and evaluation functions are designed as local electronic units (wheel modules or axle modules) that are structurally integrated into the actuators.

By the use of its own communications system between the respective braking circuit control modules and the associated axle or wheel modules, a clearly specified interface between these elements is predefined. In an advantageous manner, this permits the special configuration of the hardware components of the axle module and the wheel module, e.g. for the actuator motor used, while, on the other hand, the braking module may be used uniformly for various actuator concepts.

In an advantageous manner, the braking modules are connected by an additional communications system, such as a primary vehicle infrastructure bus, to the module or modules for recording the driver input and/or stability regulation. In one preferred exemplary embodiment, additional electronic systems, such as steer-by-wire systems, shift-by-wire systems, drive-by-wire systems, etc, are tied up to this communications system.

Because of the partition of data communications into various communications systems, the data quantity arising in the individual communications systems is further reduced, so that shorter clock cycles may be realized. This results particularly advantageously in distributed controllers and the control accuracy and/or dynamics obtainable with these.

It is particularly advantageous that, because of the named partition and connection in the case of several control systems in the vehicle, synergies come about between the individual systems, since these resources are useful in combination. Thus, for example, the control module for recording the driver's braking input, which is designed to be fault-tolerant, may also jointly take over the recording and evaluating of the steering input, the gear selection in the transmission, the power input of the drive unit, etc.

Furthermore, the cross-linkage of different partial systems simplifies the implementation of new vehicle functions, for instance of driving dynamics regulation having combined braking and steering intervention, a stop-and-go driving function, etc.

Further advantages result from the following description of exemplary embodiments, and from the dependent claims.

### BRIEF DESCRIPTION OF THE DRAWINGS

The present invention is explained in greater detail below, with the aid of the specific embodiments represented in the drawing. The only FIGURE shows an overall view block diagram of a brake-by-wire system, in which the above-named principles are implemented.

### DESCRIPTION OF THE EXEMPLARY EMBODIMENTS

The brake-by wire system shown in the FIGURE is a two-circuit braking system, each braking circuit being composed of at least one braking module 1 and 2 and at least one electrically operated braking actuator 3, 4, 5, 6. As a preferred exemplary embodiment, the FIGURE shows a solution in which there is assigned such a wheel module to each wheel. In other exemplary embodiments, the actuators for operating the wheel brakes are combined at an axle, in a wheel module, so that in this case of a four-wheel, two-axle vehicle there are only two wheel modules (so-called axle modules). Each wheel module or axle module includes one (in the case of the axle module two) brake actuators 3a, 4a, 5a, 6a, which, in the preferred exemplary embodiment of an electromechanical braking system, are designed as electric motors having a speed-transforming transmission. Furthermore, the wheel modules or axle modules have sensor technology 3b, 4b, 5b, 6b, which record the variables to be measured at the wheel or at the wheel brake, such as the rotational speed, the speed, braking force, braking torque, etc. In addition, each wheel module or axle module includes a local electronic unit 3c, 4c, 5c, 6c, which, among other things, includes the operating electronics for the brake actuator, in particular the output stage.

The wheel module or axle module are connected to brake modules 1 or 2, depending on brake circuit association, via communications systems 7 or 8. Via communications systems 7 or 8, the wheel modules transmit the recorded sensor signals, whereas actuating signals from the brake modules are passed to the wheel modules. Within the framework of output stages (3c to 6c), the wheel modules or axle modules convert the actuating signals of the brake module into activating currents for the actuator of the wheel brake. In the preferred exemplary embodiment, an electronically commutated motor is involved as the actuator. Because of the specified interface described and the spatial association of the activating electronics, hardware components may be used that are specially configured for each respective motor, without the necessity of hardware changes in the brake modules being caused thereby.

A bus system for digital data transmission is understood to be the communications system (e.g. CAN or similar bus systems).

In place of the above-mentioned electric motor-type brake actuators, in other embodiments actuators are used which use valves and/or pumps to build up braking pressure with the aid of pressure media (hydraulic, pneumatic).

As shown above, a brake module of a brake circuit is connected to its associated wheel module or axle module of the brake circuit via the brake circuit data bus (7, 8) outlined above. It optionally also takes on the voltage supply of the electrical components of the wheel module and the sensor technology associated with the wheel modules. The energy supply of the actuators themselves is supplied directly to the respective power output stages. In the preferred exemplary embodiment shown in the FIGURE, the actuators of the first brake circuit are supplied with current from energy circuit E1, and those of the second energy circuit from energy circuit E2.

In brake modules 1, 2 of each brake circuit, of which each includes at least one microcomputer, the regulation of the associated actuators of the brake circuit, the evaulation of the sensor signals and a plausibility for monitoring the sensor signals and the actuating signals for this brake circuit are carried out. In this context, in the preferred exemplary embodiment, the brake modules are supplied with voltage from both energy circuits E1 and E2, one of the energy circuits being switched over to the other in case of a fault. In the brake modules, reference variables or controlled variables for the wheel brakes are ascertained, for the associated wheel modules or axle modules, which are transmitted to the wheel modules or the axle modules via the brake circuit data bus. In the preferred exemplary embodiment, the application force applied at the wheel brake or the braking torque is regulated. In this connection, the control algorithms are calculated in the microcomputer, and the controller output signal, i.e. the controlled variable, is transmitted to the wheel module or axle module. Furthermore, the sensor signals ascertained in the wheel modules or axle modules are evaluated in the brake modules and processed further, the signals recorded by the sensors being recorded at least in part in the wheel modules or axle modules, being digitized and transmitted to the brake module via the brake circuit data bus. Examples of such sensor signals are the signals of a force sensor in the ambit of the wheel brake, of a torque sensor for recording the braking torque, a rotational speed sensor, a sensor which records tire deformation, etc. If, in other exemplary embodiments, not all sensor variables are recorded in the wheel modules or axle modules, sensor signal inputs are provided in the corresponding brake modules.

The sensor signals are processed in the brake modules and possibly checked for errors, for example within the framework of a signal range check. Furthermore, a plausibility check of the ascertained sensor signals and the activating signals is undertaken, in which context, for instance, upon the emission of a corresponding activating signal within the framework of the temporal boundary conditions, a corresponding change in the sensor signal having to be determined.

The brake modules are connected to additional modules for driver input recording 10 and for a driving dynamics control 11, via at least one additional communications system 9, which represents a vehicle infrastructure bus in one preferred exemplary embodiment. In addition, in one preferred exemplary embodiment it is provided that additional modules 12, 13, 14 may be tied in to this communications system 9, which, for safety reasons may also be designed redundant, and that these additional modules represent further control systems such as steer-by-wire systems, etc.

In one exemplary embodiment, communications system 9 and the brake circuit data busses work at different speeds and/or according to different communications protocols.

The module for driver input recording 10 records, via input signals 10a to 10f, operating signals of parking brake 15 as well as of service-brake pedal 16. Based on the recorded operating variables, module 10 forms the driver braking input which, for example, is passed on as a braking force setpoint value for the axles of the vehicle to braking modules 1 and 2, as well as to driving dynamics control 11. The latter, if necessary, for example within the framework of an electronic stability program, of a lockup protection control or a traction slip control, modulates the driver input requirements to braking requirements, individual to each wheel, which in turn are transmitted to brake modules 1 and 2 via communications system 9 for making the setting. In this context, modules 10 and 11 are also supplied with energy by both energy circuits E1 and E2, possibly in a switchable manner.

Because of the partition of data transmission into two communications planes, and thus at least three data buses (e.g. one vehicle bus, two sensor buses) the number of communications participants in the individual communications systems is reduced, compared to known systems architectures. Thus, at the same overall arising of data, higher clock-pulse rates are possible for the individual data buses.

In one embodiment, additional systems such as steer-by-wire, active body control, shift-by-wire, etc, are tied in at vehicle infrastructure bus 9. By the common use of resources, synergies may be created with respect to self-contained braking or steering systems. In addition, because of the cross-linking of the individual systems, new vehicle functions are easier to implement or are first made possible at all.

A substantial synergy potential lies in this case in the combination of functions having great safety requirements and/or fault tolerance requirements. Thus, braking input recording, steering input recording, gear selection, driver input recording for controlling a drive unit may be recorded in a central driver input module which is constructed in a fault-tolerant manner (in the FIGURE, for example, module 10). In an operating dynamics module 11, besides the primary brake control functions such as brake force balance, lockup protection control, traction slip control and an electrical stability program, functions such as driving dynamics steering interventions, variable steering ratio and other functions for driving condition-dependent modification of the setpoint value for brake, steering, drive train, engine control, etc, may also be carried out. A control module present in the vehicle, for displaying driver information (cockpit module), informs the driver concerning the operating condition and the fault condition of the braking system, based on the operating status signals of the brake module.

What is claimed is:

1. An electronic control system, especially for a vehicle braking system, having a driver input module (10) designed in a fault-tolerant manner for recording driver braking input, and having at least two brake circuit modules (1, 2) for controlling the wheel brakes, at least one electrically controllable brake actuator being associated with each brake circuit module (1, 2),
wherein a local electronic unit for executing actuator-specific control functions and/or sensor-specific evaluation functions is associated with each brake actuator, both structurally and logically, which is connected to the brake circuit module of the respective brake circuit via a local brake circuit data bus.

2. The control system as recited in claim 1,
wherein the sensor signals of each respective actuator and of the at least one wheel to which the actuator applies a braking force are recorded by the local electronic unit and made available as digital signals, if necessary, to the brake module via the brake circuit data bus.

3. The control system as recited in one of the preceding claims,
wherein the braking actuators of at least one brake circuit are designed as electromechanical actuators having an electronically commutated motor, the commutation of the motor being carried out in the local electronic unit.

4. The control system as recited in one of the preceding claims,
wherein the electrical energy supply of the local electronic units and the associated sensors is carried out via the brake circuit data bus or via the latter's physical medium.

5. The control system as recited in one of the preceding claims,
wherein the brake circuit modules are connected via a fault-tolerant communications system to one another, to the driver input module and to an optionally present control module for calculating primary brake regulating functions.

7. The control system as recited in one of the preceding claims,
wherein the control modules of the vehicle braking system are connected to control modules of additional electronic control systems via a fault-tolerant communications system, which is designed as a vehicle data bus.

8. The control system, especially as recited in one of the preceding claims,
wherein in the driver input model, besides recording the service brake input and/or the parking brake input of the driver, additionally at least one of the driver input variables steering input, driving position selection, propulsive power input is recorded, and this driver input variable is transmitted via the communications system to the corresponding control module for making a setting.

9. The control system as recited in claim 7 or 8,
wherein in the event of situations that are critical from a driving dynamics point of view, a modification of the driver steering input is undertaken in the driving dynamics module, while convenience functions, such as a variable steering ratio, are displayed.

10. (New) An electronic control system, comprising:
a driver input module designed in a fault-tolerant manner for recording a driver braking input;
at least two brake circuit modules for controlling wheel brakes;
at least one electrically controllable brake actuator associated with each brake circuit module;
a local brake circuit data bus; and
a local electronic unit for executing at least one of an actuator-specific control function and a sensor-specific evaluation function associated with each brake actuator, both structurally and logically, and being connected to each brake circuit module of a respective brake circuit via the local brake circuit data bus.

11. (New) The control system as recited in claim 10, wherein:
the control system is for a vehicle braking system.

12. (New) The control system as recited in claim 10, wherein:
sensor signals of each respective one of the at least one electrically controllable actuator and of at least one wheel to which the at least one electrically controllable actuator applies a braking force are recorded by the local electronic unit and made available as digital signals to at least one of the at least two brake circuit modules via the local brake circuit data bus.

13. (New) The control system as recited in claim 10, wherein:
the at least one electrically controllable braking actuator includes an electromechanical actuator having an electronically commutated motor, a commutation of the electronically commutated motor being carried out in the local electronic unit.

14. (New) The control system as recited in claim 10, wherein:
an electrical energy supply of the local electronic unit and associated sensors is carried out via one of the local brake circuit data bus and a physical medium thereof.

15. (New) The control system as recited in claim 10, further comprising:
a fault-tolerant communications system via which the at least two brake circuit modules are connected to one another, to a driver input module, and to an optionally present control module for calculating a primary brake regulating function.

16. (New) The control system as recited in claim 10, further comprising:
a fault-tolerant communications system including a vehicle data bus; and
a plurality of control modules connected to control modules of additional electronic control systems via the fault-tolerant communications system.

17. (New) The control system as recited in claim 10, wherein:
in a driver input model, besides recording at least one of a service brake input and a parking brake input of a driver, additionally at least one of a plurality of driver input variables pertaining to steering input, driving position selection, and propulsive power input is recorded, and
the at least one of the plurality of driver input variables is transmitted via a communications system to a corresponding control module for making a setting.

18. (New) The control system as recited in claim 17, wherein:
in the event of a situation that is critical from a driving dynamics point of view, a modification of the driver input variable pertaining to a driver steering input is undertaken in a driving dynamics module, while a convenience function including a variable steering ratio is displayed.
